(19) United States
(12) Patent Application Publication
(10) Pub. No.: US 2005/0111419 A1
(43) Pub. Date: May 26, 2005

(54) Method of performing communication over wireless network including multiple input/multiple output stations

(75) Inventors: Chang-yeul Kwon, Seongnam-si (KR); Chil-youl Yang, Yongin-si (KR); Tae-kon Kim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/970,491

(22) Filed: Oct. 22, 2004

(30) Foreign Application Priority Data
Nov. 20, 2003 (KR) 10-2003-0082742
Jan. 14, 2004 (KR) 10-2004-0002648

(51) Int. Cl. H04Q 7/24

(52) U.S. Cl. 370/338; 370/346

(57) ABSTRACT

A method for increasing transmission efficiency between stations by representing and using a new media access control (MAC) frame format for a management frame of the 802.11a standard in wireless network communication. The method including securing transmission media through a predetermined channel securing procedure at one or more Multiple Input/Multiple Output (MIMO) transmission stations, and constructing information associated with a basic service set (BSS) and a MIMO Supported Rate and carrying the information associated with the BSS and MIMO Supported Rate on the management frame at the MIMO transmission station and transmitting the carried information to at least one reception-sided station by means of the transmission media. In an IBSS network including the stations having different transmission capability, the MIMO Supported Rate information element consisting of the data transfer rate set which the MIMO stations can support is carried and transmitted on a Beacon frame, so that selection of the maximum or efficient transfer rate is guaranteed in the communication between the high-speed stations.

### CROSS-REFERENCE TO RELATED APPLICATIONS

This application claims priority from Korean Patent Application Nos. 10-2003-0082742 and 10-2004-0002648 filed on Nov. 20, 2003 and Jan. 14, 2004, respectively, in the Korean Intellectual Property Office, the disclosures of which are incorporated herein by reference.

### BACKGROUND OF THE INVENTION

1. Field of the Invention

The present invention relates to a method for increasing the transfer rate between stations within a basic service set (BSS), and more particularly, a method for increasing the transfer rate between stations within a BSS in which a new media access control (MAC) frame format is represented for a management frame of the IEEE 802.11a standard in wireless network communication, thereby increasing an efficiency in transmission between the stations.

2. Description of the Related Art

A wireless local area network (LAN) is capable of transmitting and receiving data between stations within a certain distance without requiring cabling on the floor as is typically the case with common LANs. Thus, each station is able to move freely from one location to another location within the wireless LAN.

Generally, the basic topology of the wireless LAN of the IEEE 802.11 standard is a basic service set (BSS), either an independent basic service set (IBSS) or an infrastructure BSS.

In the infrastructure BSS, an access point (AP) takes charge of transmission of a Beacon frame. An area where the Beacon frame appears defines a basic service area. The IBSS network is the IEEE 802.11 network which does not make use of the AP, and refers to an Ad-hoc network in which any station communicates directly with every other station within the BSS.

A procedure for establishing one IBSS network is as follows: First, a system management entity (SME) of the stations which are intended to establish a new BSS generates an MLME (MAC Layer Management Entity)-START.request, thus starting the establishment of the BSS. Here, the MLME-START.request, as a primitive, includes a BBS Basic Rate Set parameter and an Operational Rate Set, wherein the BBS Basic Rate Set refers to a set of data transfer rates which all stations joining the BSS must basically support, and the Operational Rate Set is a super-set including the BSS Basic Rate Set and refers to a set of data transfer rates which may be used for communication between the stations within the BSS.

In the physical (PHY) layer of the IEEE 802.11 standard, a 5 GHz OFDM (Orthogonal Frequency Division Multiplexing) mode is supported, and a data payload has {6, 12, 24} Mbps for the BBS basic rate set and {6, 9, 12, 18, 24, 36, 48, 54} Mbps for the Operational Rate Set in the IEEE 802.11a standard which allows transmission of the data with a maximum of 54 Mbps.

According to the preceding procedure, one BSS is established, and one or more stations which have initialized the BSS respectively transmit a beacon to any other station within the BSS. A Supported Rate information element included in the body of the Beacon frame transmits the Operational Rate Set, thereby becoming a starting point of the transfer rate used in the BBS later. Each station, which has received the beacon, matches each transmission capability to the Operational Rate Set of the BBS, sets the matched common portion as the Operational Rate Set, and carries Operational Rate Set on a Beacon Supported Rate information element when it is time for a station to transmit the beacon. The field includes a data transfer rate which all stations commonly use at the BSS. In other words, all stations within the BSS communicate with each other at the transfer rate.

As set forth above, by virtue of the Supported Rate information element carried on the beacon, each station is informed of the Operational Rate Set intended to be used in the BSS, wherein the Operational Rate Set contains a set of data transfer rates which can be processed in common at each station within the BSS. For example, there is a possibility that the BSS allows the joining of any station having capability to support a high-speed data transfer rate of 108 Mbps, 216 Mbps or more. In this case, if the BSS has any station providing a low-speed data transfer rate (e.g., 54 Mbps), it is not possible for the station to carry the data transfer rate beyond its capability on the Operational Rate Set.

Further, a MIMO (Multiple Input/Multiple Output) communication system based on the 802.11a standard is provided with one or more transmitting antennas on the transmission side and one or more receiving antennas on the reception side. Main transmission data is divided into a plurality of sub-data according to the number of transmitting antennas, and then each of the divided sub-data is processed and transmitted through each transmitting antenna. On the reception side, each received signal is searched for each sub-data, and each searched sub-data is decoded and processed.

In this manner, throughput of each station capable of processing according to the number of antennas is linearly increased.

As shown in FIG. 1, the data transfer rate which can be supported by each station is different according to the number of the antennas. In the case of the conventional 802.11a system, any station can support only up to 54 Mbps when communicating with any other station having a single antenna. Because the BSS is set to the minimum data transfer rate which the station having the minimum number of antennas provides, there is a problem in that even other stations capable of supporting at least the minimum data transfer rate must perform communication only at the minimum data transfer rate.

In other words, in the IBSS, consisting of a plurality of stations, when the station(s) having a single antenna and the station(s) (MIMO station) having multiple antennas communicate with each other, the Operational Rate Set of the BSS is adjusted to a common data transfer rate which all stations within the BSS can support in common. In this case, communication between the stations supporting the high-speed data transfer rate is performed at the common data transfer rate, which results in another problem in that they fail to make good use of all resources.

Therefore, it is necessary not only to guarantee the Operational Rate Set at the BSS but also to ensure communication between the stations having the multiple antennas, namely, supporting the high-speed data transfer rate.

### SUMMARY OF THE INVENTION

To solve the above-indicated problems, an object of the present invention is to provide a transfer rate recognition algorithm capable of obtaining the maximum transmission efficiency between respective stations when the stations constituting one BSS communicate with each other.

Consistent with an exemplary embodiment of the present invention, there is provided a method of performing communication over a wireless network. The method comprises the steps of: securing transmission media through a predetermined channel securing procedure at one or more Multiple Input/Multiple Output (MIMO) transmission stations, and constructing information associated with a basic service set (BSS) and an MIMO Supported Rate; and carrying the information associated with the BSS and MIMO Supported Rate on a management frame at the MIMO transmission station and transmitting the carried information to at least one reception-side station by means of the transmission media.

### BRIEF DESCRIPTION OF THE DRAWINGS

The above objects, features and advantages of the present invention will become more apparent from the following detailed description when taken in conjunction with the accompanying drawings, in which:

FIG. 1 illustrates a schematic configuration of an IBSS communication network;

FIG. 2 illustrates formats of the Beacon frame and its Frame Body according to one exemplary embodiment of the present invention;

FIG. 3A illustrates in detail a MIMO Parameter Set information element field according to one exemplary embodiment of the present invention;

FIG. 3B illustrates in detail a MIMO Capability information element field according to one exemplary embodiment of the present invention;

FIG. 4 is a schematic flow chart showing a procedure for setting a transfer rate between stations in an IBSS in accordance with one exemplary embodiment of the present invention; and

FIG. 5 illustrates a backoff procedure in detail in accordance with one exemplary embodiment of the present invention.

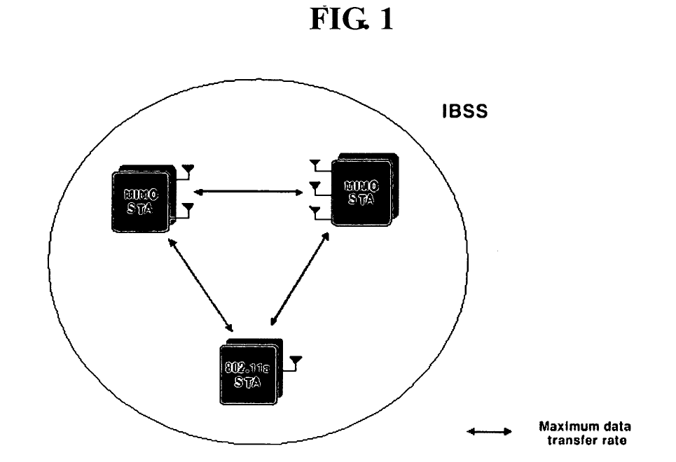

### DETAILED DESCRIPTION OF AN EXEMPLARY EMBODIMENT

Hereinafter, one embodiment of the present invention will be described in detail with reference to the accompanying drawings. A management frame of the 802.11a standard refers to a Beacon frame, a Probe Request and Response frame, or an Association Request and Response frame. The following description will be made of the Beacon frame as an example.

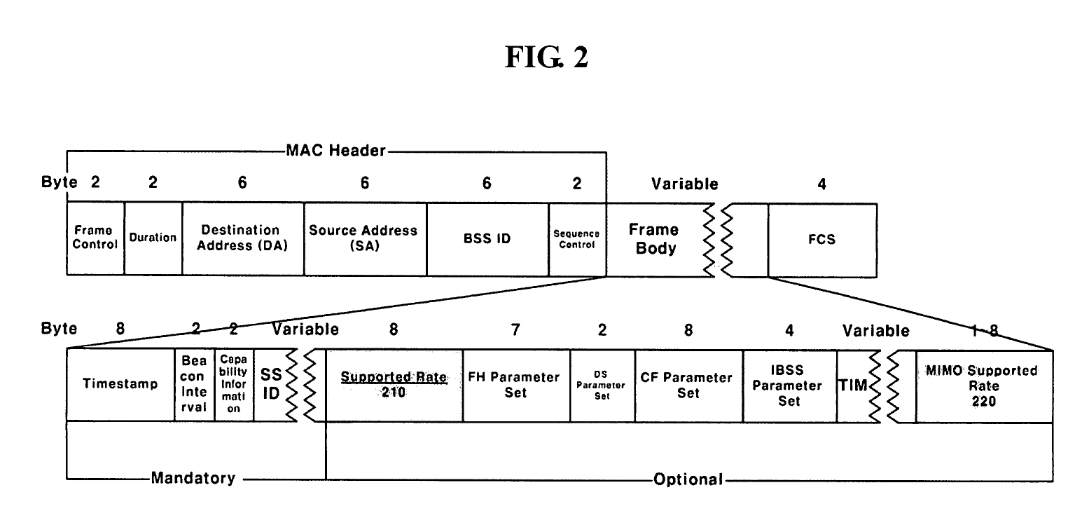

FIG. 2 illustrates formats of the Beacon frame and its Frame Body according to one exemplary embodiment of the present invention. The Beacon frame consists of the following fields: an MAC (Media Access Control) header, a Frame Body and an FCS (Frame Check Sequence). The Beacon frame gives notice of the existence of a network and plays an important role in maintenance of the network.

The Beacon frame not only causes a mobile station to correspond to a parameter so that the mobile station can join the network, but also is periodically transmitted so that the mobile station can locate and recognize the network.

The Frame Body field is a data field having a variable length. The FCS field is used to cause the station to examine integrity of a received frame.

In the 802.11a standard, a Supported Rate field 210, included in the Frame Body field is one that records information on a BSS Basic Rate Set (6, 12, and 24 Mbps) and an Operational Rate Set (6, 9, 12, 18, 24, 36, 48 and 54 Mbps) including the BSS Basic Rate Set. The Supported Rate field 210 has a length of 8 bytes and is used to indicate one transfer rate per byte. In the byte representing each transfer rate of the BSS Basic Rate Set, its MSB (Most Significant Bit) has a value of 1(one). In the byte representing each transfer rate of the Operational Rate Set, its MSB has a value of 0(null).

A MIMO (Multiple Input/Multiple Output) Supported Rate field 220 has a variable length of 8 bytes, and is a field that is added to a frame format of the 802.11a standard. The MIMO Supported Rate field 220 is recognized by MIMO stations based on the IEEE 802.11a standard, but not by stations meeting IEEE 802.11a standard.

As mentioned above, the MIMO communication system based on the IEEE 802.11a standard is provided with one or more transmitting antennas on a transmission side and one or more receiving antennas on a reception side. Main transmission data is divided into a plurality of sub-data according to the number of transmitting antennas, and then each of the divided sub-data is processed and transmitted through each transmitting antenna. On the reception side, each received signal is searched for each sub-data, and each searched sub-data is decoded and processed.

Thus, throughput which each station can process according to the number of the antennas is linearly increased. In other words, each MIMO station is capable of supporting the rates of 108, 216, 432 Mbps or more according to the number of its own antennas. Thus, a transfer rate set which each MIMO station supports is recorded in the MIMO Supported Rate field 220.

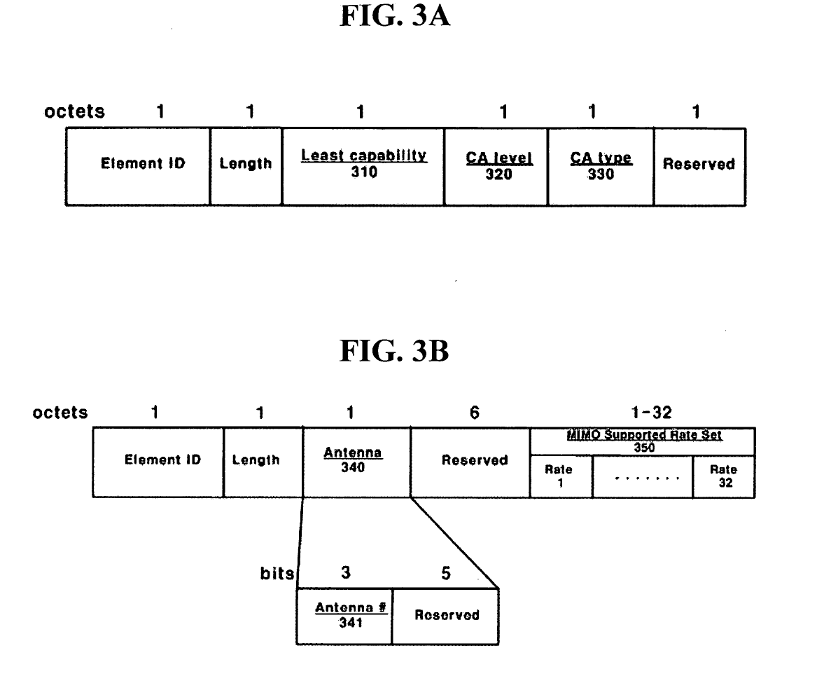

The MIMO Supported Rate field 210 has a variable length of 8 bytes and is used to indicate one transfer rate per byte. FIGS. 3A and 3B illustrate a MIMO Parameter Set information element and a MIMO Capability information element, respectively, according to one exemplary embodiment of the present invention.

As illustrated in FIG. 3A, the MIMO Parameter Set information element consists of the following fields: Element ID, Length, Least Capability 310, Collision Avoidance (CA) Level 320 and CA Type 330. Here, the Least Capability field 310 is provided with the least number of antennas which any station in the BSS has. For example, if a value of the Least Capability field 310 is 1(one), this means that any existing SISO (Single Input/Single Output) station exists in the BSS. Other values greater than or equal to two mean that any station having 2(two) or more antennas exists in the BSS. The CA Level field 320 is given three selections as follows: The first selection, Forced, forces each station to use a collision avoidance mechanism. The second selection, Recommended, recommends each station to use the collision avoidance mechanism. Finally, the third selection, Don't care, means that it doesn't matter whether each station makes use of the collision avoidance mechanism or not. The CA Type field 330 specifies that the collision avoidance mechanism is to be used, which consists of RTS (Request-To-Send)-CTS (Clear-To-Send) and self-CTS mechanisms.

As discussed above, information on the BSS is collected and used through the MIMO Parameter Set information element. Thus, the least number of antennas in the BSS, information on whether the SISO station exists or not, information on whether the collision avoidance mechanism should be used or not due to existence of the SISO station, and so forth are informed through the MIMO Parameter Set information element.

Meanwhile, an information element is a Variable Length field of a management frame. The MIMO Capability information element as illustrated in FIG. 3B consists of the following fields: Element ID, Length, Antenna 340, Reserved, and MIMO Supported Rate Set 350.

TABLE 1

| Information element | Element ID |
|---|---|
| SSID (Service Set Identifier) | 0 |
| Supported Rate | 1 |
| FH Parameter Set | 2 |
| DS Parameter Set | 3 |
| CF Parameter Set | 4 |
| TIM | 5 |
| IBSS Parameter Set | 6 |
| Reserved | 7-15 |
| Challenge Text | 16 |
| Reserved for challenge text extension | 17-31 |
| MIMO Parameter Set | 32 |
| Reserved | 33-39 |
| MIMO Capability information | 40 |
| Reserved | 41-255 |

The Element ID field has standardized values as proposed in Table 1. The Length field indicates a byte length of a subsequent MIMO Capability information element field. The Antenna field 340 indicates the number of at most eight antennas which the MIMO station can support. A 3-bit Antenna Number field 341 may express the MIMO station having at most eight antennas. The MIMO Supported Rate Set field 350 is encoded with 32 octets capable of supporting a maximum of 32 transfer rates, wherein each octet indicates one transfer rate. Further, one octet corresponds to any one of the data transfer rates from 500 Kb/s to 5*255 Mb/s by an increment of 500 Kb/s. The MIMO station having four antennas supports a Supported Rate set {27, 72, 96, 108, 144, 162, 192 and 216}.

As set forth above, information on each MIMO station is collected and used through the MIMO Capability information element, and the Supported Rate and antenna number of each station are informed through the MIMO Capability information element.

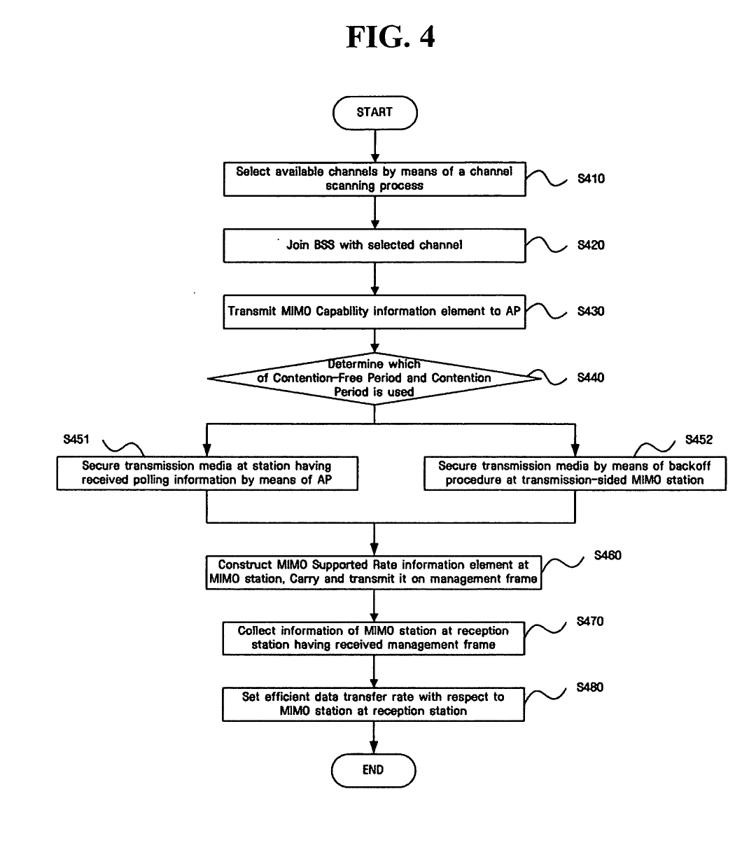

FIG. 4 is a flow chart showing a procedure of establishing an infrastructure-based network and simultaneously performing communication between stations in accordance with one exemplary embodiment of the present invention.

An access point (AP) selects at least one available channel through a channel scanning process (S410). The detailed channel scanning process of scanning each channel is as follows: At an MLME (MAC Layer Management Entity), scanning is initiated by an MLME-SCAN.request, which includes a scanning type, a channel list and so on. Then, SSID (Service Set Identifier) and MIMO Capability information element for the next channel are carried and transmitted on a Probe Request frame. In response to this, a reception station receives a Probe Response frame including Capability information, SSID, MIMO Capability information (Extended Supported Rate), CF Parameter Set, IBSS Parameter Set, and so on. After receiving the Probe Response frame, the reception station informs the MLME of an MLME-SCAN.confirm including BSS Description Set (PHY Parameter Set, CF Parameter Set, IBSS Parameter Set, Capability information, BSS Basic Rate Set, etc.) and Result Code. Thereafter, the channel scanning process is terminated.

On establishing the BSS with the selected channel, respective stations are associated through the channel (S420).

When being associated, each station informs the AP of its own transmission capability through the MIMO Capability information element (S430). The AP gets information of all stations in the BSS. For example, information of a station may be information on whether the station exists or not, Support Rates of each station, and so forth.

One super-frame is comprised of at least two fields: a Contention-Free Period and a Contention Period. It is determined which of the Contention-Free Period and the Contention Period is used (S440). During the Contention-Free Period, the AP polls each station so that each station can perform communication (S451). Only the polled station(s) can perform communication. During the Contention Period, communication is performed with an existing backoff mechanism (S452). In other words, a transmission-sided MIMO station in the IBSS secures transmission media through a backoff procedure. The MIMO station constructs the MIMO Supported Rate information element 300, carries it on a Beacon frame by means of the transmission media, and transmits the carried result to a reception-sided station (S460). The reception-sided station receiving the Beacon frame collects the MIMO Supported Rate information element 300 (S470). Finally, the reception-sided station reads out the MIMO Supported Rate information element 300 to set an efficient data transfer rate with the MIMO station (S480).

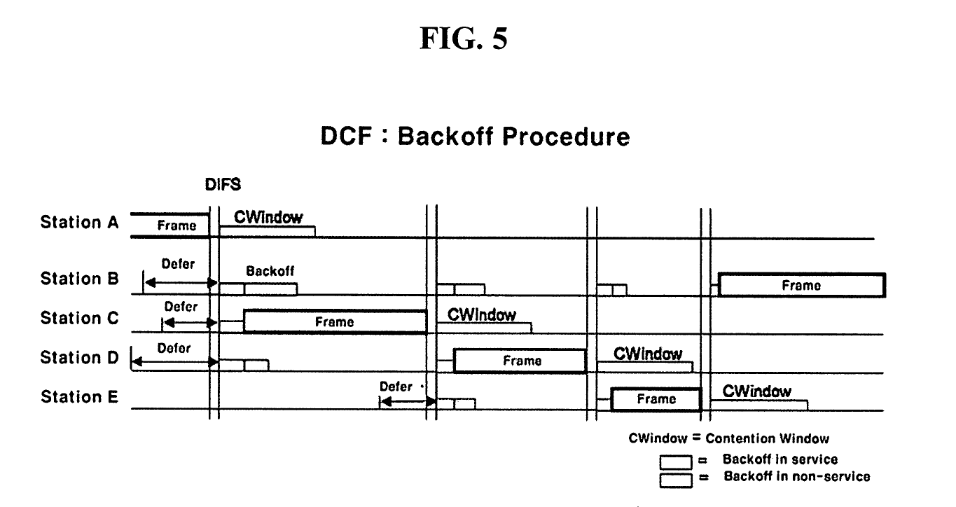

FIG. 5 illustrates a backoff procedure in detail in accordance with one exemplary embodiment of the present invention. An access to transmission media in IEEE 802.11 makes use of a DCF (Distributed Coordination Function) and a PCF (Point Coordination Function). The DCF provides a Contention based service, while the PCF provides a Contention-Free based service. The DCF uses a CSMA/CA (Carrier Sense Multiple Access/Collision Avoidance) as an access protocol, and makes use of a rotating backoff window mechanism in order to prevent a collision. In the DCF, a reference of determining whether the transmission media is used or not is a DIFS (DCF InterFrame Space) of about 34 μs.

As shown in FIG. 5, after the DIFS, a predetermined magnitude of contention window period is set. A magnitude of random slots having the same possibility to be selected by a backoff algorithm is allocated to each station in the IBSS which takes part in the contention. The magnitude of the contention window period is one less than a power of 2, and for example, has values of 31, 63, 127, 255, etc. which are limited to 1023 due to a restriction of a physical layer.

If a frame transmission of station A that is using a current channel is ended, stations B, C and D that have deferred the frame transmission take part in contention for securing channels after the DIFS. In the first contention window period, when a backoff timer of the station C that selects a minimum backoff time becomes 0(zero), the frame transmission is initiated. In the second contention window period after the next DIFS, the stations B, D and E take part in contention and perform the same procedure as the foregoing procedure. As a result, the station D secures the transmission media to initiate the frame transmission. In the third contention window period, the stations B and E take part in contention and perform the same procedure as the foregoing procedure. As a result, the station E secures the transmission media to initiate the frame transmission. In the fourth contention window period, the station B takes part in contention and performs the same procedure as the foregoing procedure. As a result, the station B secures the transmission media to initiate the frame transmission.

As set forth above, when any station within the IBSS network makes use of wireless media through the backoff procedure, the station constructs the MIMO Supported Rate information element 300 including information on a set of data transfer rates which the MIMO stations can support, carries it on the Beacon frame, and transmits the carried result. Any other MIMO or SISO station, which communicates with the MIMO stations in the IBSS network, recognizes the Supported Rates of the MIMO stations, which have transmitted the Beacons, from the Beacons, and then selects a predetermined Supported Rate of the recognized Supported Rates to perform communication at an efficient data transfer rate.

According to the invention, in the IBSS network including the stations having different transmission capability, the MIMO Supported Rate information element consisting of the data transfer rate set which the MIMO stations can support is carried and transmitted on the management frame, so that selection of the maximum or efficient transfer rate is guaranteed in the communication between the high-speed stations.

Further, a foundation capable of avoiding a collision when MIMO stations in accordance with IEEE 802.11a co-exist is provided, so that it is possible to use various collision avoidance mechanisms.

While the present invention has been described with reference to certain exemplary embodiments thereof, it will be understood by those skilled in the art that the invention may be implemented in a different specific form without changing the technical spirit or essential characteristics thereof. Therefore, it should be understood that the foregoing embodiments are illustrated in all respects but not limited.

The scope of protection of the present invention will be defined by the appended claims rather than the detailed description. Thus, it should be understood by those skilled in the art that all modifications or changes in form and details derived from the claims and their equivalents might not depart from the scope of protection of the invention.

1. A method of performing communication over wireless network, the method comprising:
securing transmission media through a predetermined channel securing procedure at at least one Multiple Input/Multiple Output transmission station, and constructing information associated with a basic service set and a Multiple Input/Multiple Output Supported Rate; and
carrying the information associated with the basic service set and Multiple Input/Multiple Output Supported Rate on a management frame at the Multiple Input/Multiple Output transmission station and transmitting the carried information to at least one reception-sided station by means of the transmission media.

2. The method as claimed in claim 1, wherein the channel securing procedure comprises receiving polling information from an access point, at the Multiple Input/Multiple Output transmission station.

3. The method as claimed in claim 1, wherein the channel securing procedure makes use of a backoff algorithm.

4. The method as claimed in claim 1, wherein the management frame observes the IEEE 802.11a standard.

5. The method as claimed in claim 1, wherein the management frame comprising a Beacon frame.

6. The method as claimed in claim 1, wherein the management frame comprises a Probe Request and Response frame.

7. The method as claimed in claim 1, wherein the management frame comprises an Association Request and Response frame.

8. The method as claimed in claim 1, wherein the information associated with the basic service set comprises a Multiple Input/Multiple Output Parameter Set information element field including at least one of a Least Capability field referring to the least number of antennas with which the Multiple Input/Multiple Output transmission station is provided, a Collision Avoidance Level field indicating three levels of Forced, Recommended and Don't care, and a Collision Avoidance Type field indicating a Request-To-Send-Clear-To-Send mechanism and a self- Clear-To-Send mechanism.

9. The method as claimed in claim 1, wherein the information associated with the Multiple Input/Multiple Output Supported Rate comprises a Multiple Input/Multiple Output Capability information element field including at least one of an Antenna field indicating the number of antennas, and a Multiple Input/Multiple Output Supported Rate Set field consisting of a transfer rate set which the Multiple Input/Multiple Output transmission station can support.

10. The method as claimed in claim 5, wherein the Multiple Input/Multiple Output transmission station can support a transfer rate set, the transfer rate set including at least one of 108 Mbps, 216 Mbps, and 432 Mbps.

11. The method as claimed in claim 8, wherein the Multiple Input/Multiple Output Parameter Set information element field is added to the management frame of the 802.11a standard.

12. The method as claimed in claim 1, wherein the reception-sided station is any one of a Multiple Input/Multiple Output station and a Single Input/Single Output station.

13. The method as claimed in claim 5, further comprising reading out a Multiple Input/Multiple Output Capability information element field to select a predetermined transfer rate of a transfer rate set, at the reception-sided station, and setting the transfer rate with the Multiple Input/Multiple Output transmission station.
